(19) United States
(12) Patent Application Publication
(10) Pub. No.: US 2026/0319937 A1
(43) Pub. Date: Oct. 15, 2026

(54) CLOUD-NATIVE TEST BED GENERATION AND BUILD

(71) Applicant: Telefonaktiebolaget LM Ericsson (publ), Stockholm (SE)

(72) Inventors: Sahar TAHVILI, Solna (SE); Chen SONG, Sollentuna (SE); Jiecong YANG, Uppsala (SE); Theofilos TORONIDIS, Sundbyberg (SE); Ramana Reddy AVULA, Borås (SE); Animesh SINGH, Stockholm (SE)

(73) Assignee: Telefonaktiebolaget LM Ericsson (publ), Stockholm (SE)

(21) Appl. No.: 19/104,491

(22) PCT Filed: Jul. 19, 2023
(86) PCT No.: PCT/EP2023/070057

§ 371 Date: Feb. 18, 2025

(30) Foreign Application Priority Data
Aug. 31, 2022 (GR) 20220100716

(51) Int. Cl. G06F 11/3668

(52) U.S. Cl. CPC G06F 11/3696; G06F 11/3684

(57) ABSTRACT

A method performed by a computing device for initiation of a build of a cloud-native radio access network, RAN, test bed is provided. The method includes receiving (100) attributes of the cloud-native RAN for requested test bed; and generating (102), based on the attributes, a configuration for the requested test bed. The configuration includes an identifier that identifies at least one or more of the attributes of the cloud-native RAN and at least one or more hardware components for the requested test bed. The method further includes generating (104), from a machine learning, ML, model based on the configuration, an identification of hardware components that satisfy the configuration; and initiating (114) an automated build of the requested test bed from the identification.

### TECHNICAL FIELD

The present disclosure relates generally to a method performed by a computing device for initiation of a build of a cloud-native radio access network (RAN) test bed, and related methods and apparatuses.

### BACKGROUND

For testing cloud RAN applications, such as a virtual distributed unit (vDU) and/or a virtual centralized unit (vCU), a test environment (also referred to herein as a “test bed” and/or also known as “test channel”) can be needed. A test bed typically may include several cloud-native infrastructures such as different hardware and software. Each test bed can have different capacities that can be used for testing different features and, thereby, have different costs. As the number of cloud applications increases, more test beds may be needed for testing cloud application features before releasing the cloud applications to the market.

For example, during product development, a full-stack virtualization may be built of a fifth generation (5G) new radio (NR) vCU and vDU based on commercial off-the-shelf (COTS) hardware using cloud-native technologies; and a product development team may work with a customer to deliver a virtualized RAN. During product development, vDU for low band (LB) (e.g., sub 6 GHZ) may be developed, for example. In order to accelerate product development, cloud-native infrastructures and technologies may need to be utilized. Moreover, the cloud products may need to be tested on several testing levels such as unit, integration, and system acceptance testing.

For testing different parts of the products and applications, macro functionalities of the system may need to be developed and tested. Features can be specified gradually during the testing process using different cloud-native test infrastructures. As previously referenced, since test beds can have different capacities, the test beds can have different costs as well. Costs can include, without limitation, a building cost of a test bed that includes assembling hardware components and software installation; maintenance costs; manpower (e.g., usage of manpower) costs; footprint costs; license costs, etc. The various costs can be included in a total cost of a cloud-native test bed. A total cost of a cloud-native test bed can be expensive, especially for those that have high capacity and are designed to test a variety of features, for example. An example of the total cost may be estimated between 0.2 M SEK and 7M SEK, where a significant portion of the total cost is related to the hardware components.

A challenge for building a new test bed can include mapping capacity with actual requests and demands. Building a new test bed can be a time and resource-consuming process, where several subject matter experts from different teams (e.g., the design team, the lab team, etc.) are involved. Building a test bed that can be used for testing a wide range of features (e.g., different radio frequencies, simulators, 4G, 5G, etc.) may be desirable. Some approaches, however, may introduce problems including using manual forecasting approaches based on existing test beds or a project's demand, for example. Employing a manual demand-based forecasting approach for building a new test bed can lead to over or underestimating the capacities of the test bed. See e.g., Chinese Patent No. CN112598309A; Chinese Patent No. CN109388484A.

### SUMMARY

There currently exist certain challenges. Automatic generation of both a configuration for a requested cloud-native RAN test bed and an identification of hardware components that satisfy the configuration may be lacking. Automatic generation, however, may be important for at least the following reasons: acceptable accuracy of a build of the requested test bed; generation of a compatible configuration for testing a cloud-based application; scalability to handle multiple requests; on-demand generation of test bed configurations; and/or on-demand building of requested test beds.

Certain aspects of the disclosure and their embodiments may provide solutions to these or other challenges.

In some embodiments, a method performed by a computing device for initiation of a build of a cloud-native RAN test bed is provided. The method includes receiving (100) a plurality of attributes of the cloud-native RAN for requested test bed; and generating (102), based on the plurality of attributes, a configuration for the requested test bed. The configuration includes an identifier that identifies at least one or more of the plurality of attributes of the cloud-native RAN and at least one or more hardware components for the requested test bed. The method further includes generating (104), from a machine learning (ML) model based on the configuration, an identification of hardware components that satisfy the configuration; and initiating (114) an automated build of the requested test bed from the identification.

In some embodiments, a computing device configured for initiation of a build of a cloud-native RAN test bed is provided. The computing device includes processing circuitry; and memory coupled with the processing circuitry. The memory includes instructions that when executed by the processing circuitry causes the computing device to perform operations. The operations include to receive a plurality of attributes of the cloud-native RAN for requested test bed; and to generate, based on the plurality of attributes, a configuration for the requested test bed. The configuration includes an identifier that identifies at least one or more of the plurality of attributes of the cloud-native RAN and at least one or more hardware components for the requested test bed. The operations further include to generate, from a ML model based on the configuration, an identification of a plurality of hardware components that satisfy the configuration; and to initiate an automated build of the requested test bed from the identification.

In some embodiments, a computing device configured for initiation of a build of a cloud-native RAN test bed is provided. The computing device adapted to perform operations. The operations include to receive a plurality of attributes of the cloud-native RAN for requested test bed; and to generate, based on the plurality of attributes, a configuration for the requested test bed. The configuration includes an identifier that identifies at least one or more of the plurality of attributes of the cloud-native RAN and at least one or more hardware components for the requested test bed. The operations further include to generate, from a ML model based on the configuration, an identification of a plurality of hardware components that satisfy the configuration; and to initiate an automated build of the requested test bed from the identification.

In some embodiments, a computer program is provided that includes program code to be executed by a processing circuitry of a computing device configured for initiation of a build of a cloud-native RAN test bed. Execution of the program code causes the computing device to perform operations. The operations include to receive a plurality of attributes of the cloud-native RAN for requested test bed; and to generate, based on the plurality of attributes, a configuration for the requested test bed. The configuration includes an identifier that identifies at least one or more of the plurality of attributes of the cloud-native RAN and at least one or more hardware components for the requested test bed. The operations further include to generate, from a ML model based on the configuration, an identification of a plurality of hardware components that satisfy the configuration; and to initiate an automated build of the requested test bed from the identification.

In some embodiments, a computer program product including a non-transitory storage medium including program code to be executed by processing circuitry of a computing device is provided. Execution of the program code causes the computing device to perform operations. The operations include to receive a plurality of attributes of the cloud-native RAN for requested test bed; and to generate, based on the plurality of attributes, a configuration for the requested test bed. The configuration includes an identifier that identifies at least one or more of the plurality of attributes of the cloud-native RAN and at least one or more hardware components for the requested test bed. The operations further include to generate, from a ML model based on the configuration, an identification of a plurality of hardware components that satisfy the configuration; and to initiate an automated build of the requested test bed from the identification.

### BRIEF DESCRIPTION OF DRAWINGS

The accompanying drawings, which are included to provide a further understanding of the disclosure and are incorporated in and constitute a part of this application, illustrate certain non-limiting embodiments of inventive concepts. In the drawings:

FIG. 1 is a flow chart illustrating a method performed by a computing device in accordance with some embodiments;

FIG. 2 is a block diagram of an example embodiment of operations of the flowchart of FIG. 1;

FIG. 3 is a block diagram of the rule-based operation of an example embodiment of generating a configuration;

FIG. 4 is a block diagram of an example embodiment of generating an identification of hardware components that satisfy the configuration;

FIG. 5 is schematic diagram illustrating an example embodiment of generating the identification of hardware components;

FIG. 6 is schematic diagram illustrating a graphical user interface in accordance with some embodiments of the present disclosure;

FIG. 7 is a flowchart of operations of computing device in accordance with some embodiments of the present disclosure;

FIG. 8 is a flowchart of operations of a computing device in accordance with some embodiments of the present disclosure;

FIG. 9 is a schematic diagram illustrating a graphical user interface in accordance with some embodiments of the present disclosure;

FIG. 10 is a block diagram of an overview of a distributed computing device illustrating a cloud implementation in accordance with some embodiments of the present disclosure;

FIG. 11 illustrates three specific examples of a computing device that may be used to implement particular embodiments of the present disclosure; and

FIG. 12 illustrates a further implementation example for particular embodiments of the present disclosure.

### DETAILED DESCRIPTION

Inventive concepts will now be described more fully hereinafter with reference to the accompanying drawings, in which examples of embodiments of inventive concepts are shown. Inventive concepts may, however, be embodied in many different forms and should not be construed as limited to the embodiments set forth herein. Rather, these embodiments are provided so that this disclosure will be thorough and complete, and will fully convey the scope of present inventive concepts to those skilled in the art. It should also be noted that these embodiments are not mutually exclusive. Components from one embodiment may be tacitly assumed to be present/used in another embodiment.

The following description presents various embodiments of the disclosed subject matter. These embodiments are presented as teaching examples and are not to be construed as limiting the scope of the disclosed subject matter. For example, certain details of the described embodiments may be modified, omitted, or expanded upon without departing from the scope of the described subject matter.

The terms “build” or “building” herein is used in a non-limiting manner and can refer to any type of activation (e.g., via switches), connection between (e.g., via wired or wireless communication links), or deployment of hardware components for a cloud-native RAN test bed.

In order to build a new test bed, several criteria may need to be considered, including a specific timeline for readiness and an accurate capacity, for example. Manual forecasting of an amount of needed test beds, as well as their capacity, can directly impact the usage and timing of the testing resources. Moreover, a manual process can suffer from errors in human judgment, ambiguity, and uncertainty. For example, using manual forecasting for building a test bed may result in a maximum capacity of the test bed not being used.

Some approaches lack automated generation of a test bed and/or automated build of a test bed and may have one or of the following challenges: manual data gathering that lacks ability to automatically generate an input to a ML model (e.g., a deep reinforcement learning (RL) model); an unsupervised learning approach due to a lack of labeled data; scalability challenges and sensitivity to changes in a new request; lack of automated generation of a configuration of a requested test bed; lack of automated build of a requested test bed; lack of provision and/or consideration of different scenarios for an action; and/or lack of acceptable accuracy for an actual industrial application.

Certain aspects of the disclosure and their embodiments may provide solutions to these or other challenges. In some embodiments, a computer-implemented method is performed by a computing device for a build of a cloud-native RAN test bed. Cloud-native RAN refers to implementing RAN functions over a computing platform and managing RAN application virtualization using cloud computing, e.g., running a RAN network function(s) through COTS hardware platforms. Operations of some embodiments can include use of a ML-based expert system (that is, an ML model) for building the cloud-native RAN test bed based on input from an end-user (e.g., a tester), where the capacity of a built test bed is based on an actual request and usage. Moreover, operations of some embodiments include identification of dependencies between cloud RAN infrastructures and provision of options for keeping, reusing, modifying, or disassembling a test bed that is built after the testing process is done.

In some embodiments of operations, the ML model automatically captures input (e.g., an end-user's input) and provides a list or other identification of cloud-native hardware components for building a new test bed(s). The new test bed(s) can be built dynamically and thus, may facilitate the testing process and on-time delivery.

The ML model of some embodiments provides a set of high-level cloud RAN attributes (e.g., on a display to an end user) and can automatically generate a configuration (e.g., exact needed capability) for building a new cloud-native test bed. The ML model of some embodiments can also provide a dynamic inventory based on the generated configuration and can select the hardware components for the generated configuration dynamically. Moreover, in some operations, the ML model can continuously consider the cost, compatibility, and/or availability of each cloud-native hardware component for building a new test bed. Furthermore, in some embodiments of operations, the ML-based model can predict the availability of already assigned cloud-native hardware components, while the ML model is considering a starting date and a life span (in other words, duration) for the cloud-native test bed(s). Additionally, the operations of some embodiments include an automated decision by the ML model regarding keeping, modifying, or disassembling a test bed.

For ease of discussion, example embodiments herein are explained in the non-limiting context of initiating an automated build of a requested cloud-native RAN test bed. The present disclosure, however, is not so limited and, in some embodiments, a generated identification of hardware components that satisfy a configuration for the requested test bed is provided without initiation of an automated build of the requested test bed. For example, in some embodiments, the build may not be automated (or may not be completely automated), for example when a control system for implementing an automated build is not available.

As used herein, the term “computing device” refers to equipment capable, configured, arranged, and/or operable to initiate a build of a cloud-native RAN test bed in accordance with embodiments of the present disclosure. As discussed further herein, examples of computing devices include, without limitation, a centralized device, a distributed device having distributed logical and/or physical entities, a standalone device in a location near the site, a border device, an edge device, a cloud-based device, etc. For example, when the computing device includes a logical entity, part of the computing device may be cloud-based. For example, performing an operation of the method may be seen at the same logical device, but with different physical devices, etc.

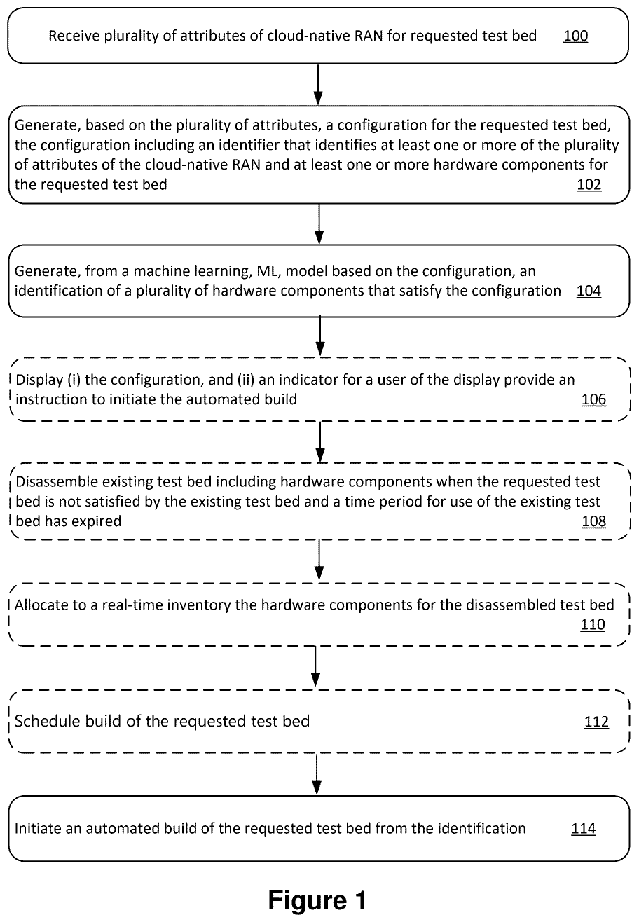

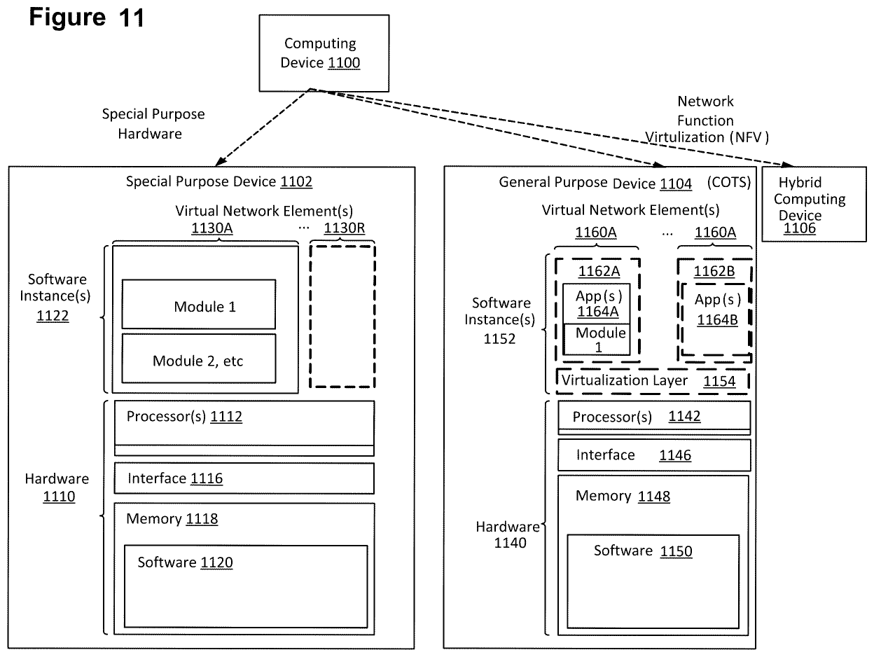

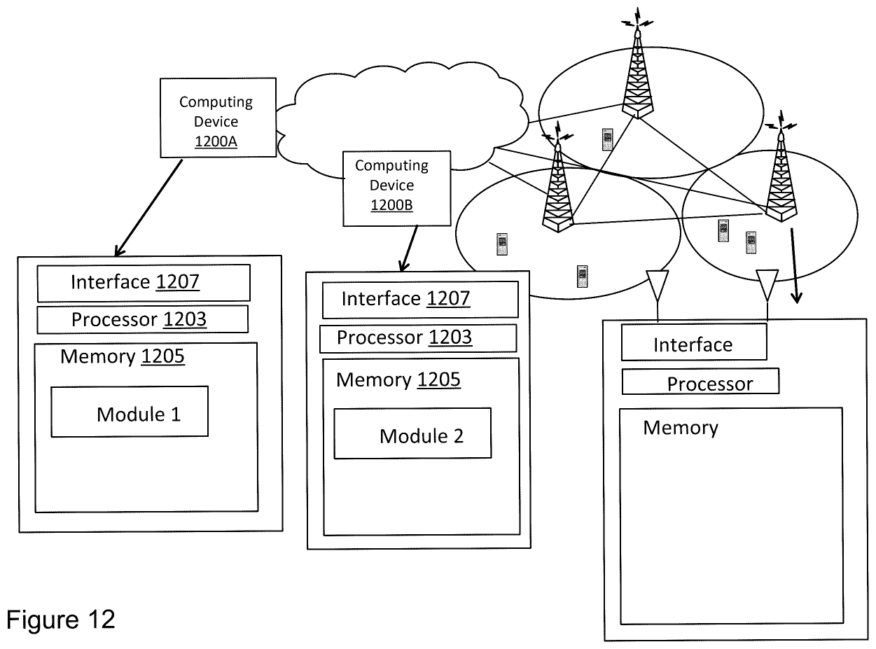

FIG. 1 is a flow chart illustrating a method performed by a computing device (e.g., computing device 1100, 1200 implemented using the structure of FIG. 11 or 12) in accordance with some embodiments. For ease of discussion, an overview of some of the operations of the method of FIG. 1 is discussed below, followed by a more detailed discussion of the operations of FIG. 1. The operations from the flow chart of FIG. 1 may be optional with respect to some embodiments of computing devices and related methods. For example, operations of blocks 106-112 may be optional.

Referring to FIG. 1, a computer implemented method performed by a computing device for initiation of a build of a cloud-native RAN test bed is provided. The method includes receiving (100) a plurality of attributes of the cloud-native RAN for requested test bed. The method further includes generating (102), based on the plurality of attributes, a configuration for the requested test bed. The configuration includes an identifier that identifies at least one or more of the plurality of attributes of the cloud-native RAN and at least one or more hardware components for the requested test bed. The method further includes generating (104), from a ML model based on the configuration, an identification of a plurality of hardware components that satisfy the configuration. The method further includes initiating (114) an automated build of the requested test bed from the identification.

Technical advantages provided by certain embodiments of the present disclosure may include that, e.g., in contrast to approaches lacking automated generation of a configuration, based on the inclusion in the method of automated generation of identification hardware components that satisfy the configuration, and/or initiation of an automated build of the requested test bed from the identification, accuracy may increase based on reduction of human error; a compatible configuration for testing a cloud-based application may be generated; and knowledge of humans needed of a cloud RAN domain for building a new test bed may be reduced. Additional technical advantages may include that based on inclusion of different ML-based strategies (as discussed further herein) a large number of requests for building cloud-native test beds may be achieved such that the method may be scalable. Further, technical advantages may include that based on inclusion of identification of dependencies between hardware components (e.g., which may be missed in manual approaches), the method may automatically select hardware components considering the dependencies. Moreover, based on inclusion of dynamic, on-demand generation of test bed configurations, on-demand building of requested test beds and/or a dynamic inventory of hardware components (discussed further herein), the method also may reduce energy consumption of cloud-native infrastructures.

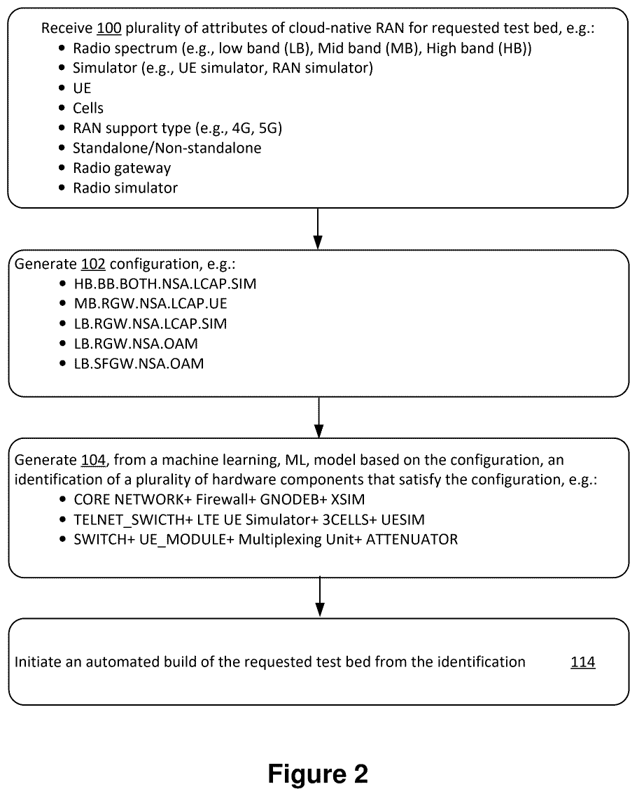

FIG. 2 is a block diagram of an example embodiment of operations 100, 102, 104, and 114 of the flowchart of FIG. 1. A plurality of attributes (e.g., high-level cloud-native RAN attributes) for a requested test bed can be provided to an end-user to choose and, in operation 100, are captured as input by the computing device. As illustrated in the example of FIG. 2, the received 100 plurality of attributes can include, for example: a radio spectrum (e.g., low band (LB), mid band (MB), high band (HB)); a type of RAN simulator (e.g., a user equipment (UE) simulator, a RAN simulator); a type of UE, a type of RAN support (e.g., fourth generation (4G), 5G), a standalone (SA) or non-standalone (NSA) mode, a radio gateway (RGW), and a radio simulator. In an example embodiment, the plurality of attributes includes one or more of (i) a radio spectrum, (ii) a model, brand, or name of a simulator, (iii) a type of UE, (iv) a cell type, (v) a quantity of cells, (vi) a type of RAN support, (vii) a standalone or a non-standalone mode, (viii) a type of traffic, and (ix) a radio gateway. It is understood that the attributes can be modified based on the new cloud-based applications.

The received 100 attributes are used in operation 102 to generate a configuration. The computing device analyzes the captured information from operation 100, and automatically generates a configuration for building the requested test bed. In an example embodiment, the generating (102) the configuration includes analyzing at least one or more of the plurality of attributes of the cloud-native RAN and the at least one or more hardware components for the requested test bed from the configuration based on use of a set of rules that identifies dependencies between (i) at least two attributes from the configuration, and/or between at least one hardware component and at least one attribute from the configuration. The rules can include attributes that cannot be selected at the same time (e.g., because they are not compatible with) and/or attributes that can ve selected at the same time (e.g., because they are compatible or needed together).

As previously discussed, the generated 102 configuration includes an identifier that identifies at least one or more of the plurality of attributes of the cloud-native RAN and at least one or more hardware components for the requested test bed. As illustrated in the example of FIG. 2, the identifier of generated 102 configuration includes a sequence of characters that identifies the configuration, e.g., as illustrated one of:
HB.BB.BOTH.NSA.LCAP.SIM (i.e., High Band.Baseband.Both.Non-Standalone.Low Capability.Simulator, where “BOTH” indicates a type/brand of a simulator and a UE).
MB.RGW.NSA.LCAP.UE (i.e., Mid Band.Radio Gateway.Non-Standalone.Low Capability.User Equipment).
LB.RGW.NSA.LCAP.SIM (i.e., Low Band.Radio Gateway.Non-Standalone.Low Capability.Simulator)
LB.RGW.NSA.OAM (i.e., Low Band.Radio Gateway.Non-Standalone.Operation and Maintenance)
LB.SFGW.NSA.OAM (i.e., Low Band.Software Frontal Gateway.Non-Standalone.Operation and Maintenance)

The generated 102 configuration can be considered as an identifier that represents the capabilities of the cloud-native RAN test bed.

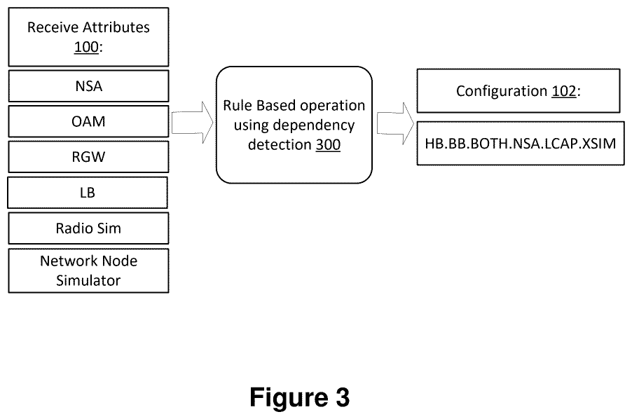

FIG. 3 is a block diagram of a rule-based operation of an example embodiment of generating 102 the configuration. As previously discussed, the rule-base operation 300 uses a set of rules that identifies dependencies between (i) at least two attributes from the configuration, and/or between at least one hardware component and at least one attribute from the configuration. Thus, this operation considers that there are some dependencies between attributes and, thereby, between hardware components.

In contrast, some approaches do not pay attention to such dependencies and, thus, can miss some hardware components for building the test bed. Moreover, some approaches may not include dependencies because knowing the dependencies between attributes, and thereby the hardware components, can require deep knowledge of the domain which may be missing.

In some embodiments of the present disclosure, in order to minimize the risk of missing such important information, a set of rules is included that identifies dependencies. Prior to generation of the configuration, for example, the rules can be checked to verify dependency between the attributes. In the example embodiment of FIG. 3, if an end-user selects a simulated radio unit (represented by “Radio Sim” in FIG. 3), the computing device automatically selects a particular simulator (e.g., represented by “XSIM” in FIG. 3) due to the dependencies between the two attributes. Table 1 below illustrates an example embodiment of a set of rules that identifies dependencies:

| Root | Type | Dependent (Leaf) | Type |
|---|---|---|---|
| CTX | Attribute | Radio Sim | Hardware Unit |
| RGW | Attribute | ASIM, XSIM, BSIM | Hardware Unit |
| Server | Attribute | Z server | Hardware Unit |
| Type | | | |
| HB | Attribute | MS-RBS | Hardware Unit |
| MB | Attribute | Not compatible with RGW | Attribute |

As shown in Table 1, there are some dependencies both between the attributes and also between the hardware components.

Referring to FIG. 2, operation 104 includes generating, from the ML model based on the configuration, an identification of a plurality of hardware components that satisfy the configuration. In the example of FIG. 2, the hardware components can include one of the following combinations:
CORE NETWORK+FIREWALL+GNODEB+XSIM
TELNET_SWICTH+LTE UE SIMULATOR+3CELLS+UESIM
SWITCH+UE_MODULE+MULTIPLEXING UNIT+ATTENUATOR

In other words, the automatically generated configuration for building the requested test bed from operation 102 is used in operation 104 for identifying the hardware components for building the requested test bed.

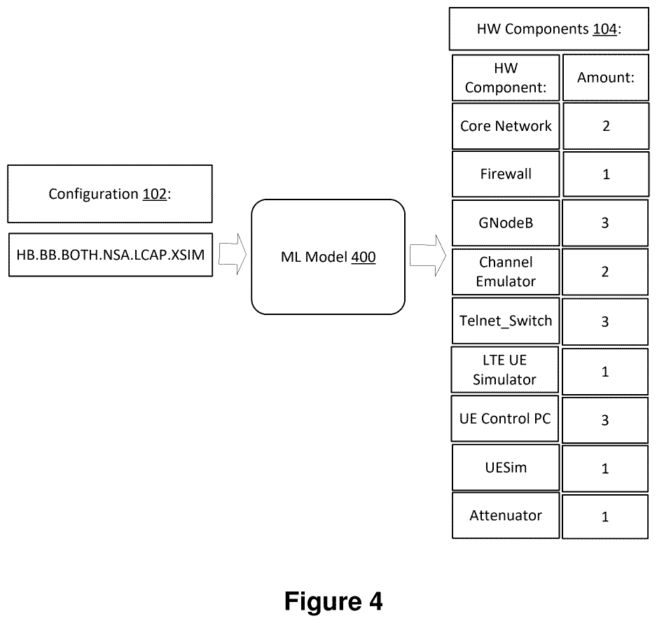

FIG. 4 is a block diagram of an example embodiment of generating 104, from a ML model based on the configuration, an identification of a plurality of hardware components that satisfy the configuration. In an example embodiment, the ML model 400 includes one of a rule-base model and a ML regression model, and the generating 104 the identification of the plurality of hardware components that satisfy the configuration includes: (i) providing the configuration to the ML model, and (iii) selecting the plurality of hardware components that satisfy the configuration based on calculation of a reward value.

As shown in the example in FIG. 4, the configuration generated in operation 102 is input to ML model 400, and ML model 400 can automatically generate the hardware components for the requested test bed. As illustrated in FIG. 4, the identification of the hardware components can include a type/name of the respective hardware components and respective quantities of each hardware quantity. In an example embodiment, the identification of a plurality of hardware components that satisfy the configuration includes an identification of a quantity of each hardware component from the plurality of hardware components.

In some embodiments, the identification of the plurality of hardware components that satisfy the configuration is sent to display (e.g., to a lab for building the requested test bed). For example, in some embodiments as shown in FIG. 1, the method further includes displaying (106) on one of a graphical user interface or a display (i) the configuration, and (ii) an indicator for a user of the display to provide an instruction to initiate the build.

As previously discussed with regard to FIG. 1, the method further includes initiating (114) an automated build of the requested test bed from the identification (e.g., from the example identification of hardware components 104 illustrated in FIG. 4).

Maintaining a built test bed(s) for a long period of time may not be an optimal decision. In order to try to increase usage of the hardware components, in some embodiments, the test bed(s) is created for on-demand usage. In other words, if the computing device is not receiving a new request for building a new test bed with a same configuration, the built test bed is disassembled and the hardware components can be sent back to inventory. For example, in some embodiments as shown in FIG. 1, the method further includes disassembling (108) an existing test bed including a plurality of hardware components when the requested test bed is not satisfied by the existing test bed and a time period for use of the existing test bed has expired; and allocating (110) to a real-time inventory the plurality of hardware components for the disassembled test bed. As previously discussed, the computing device can use either rule-based or a ML regression model (e.g., a deep RL mode) to generate the identification for building the requested test bed(s). The identification may satisfy different requests from end users.

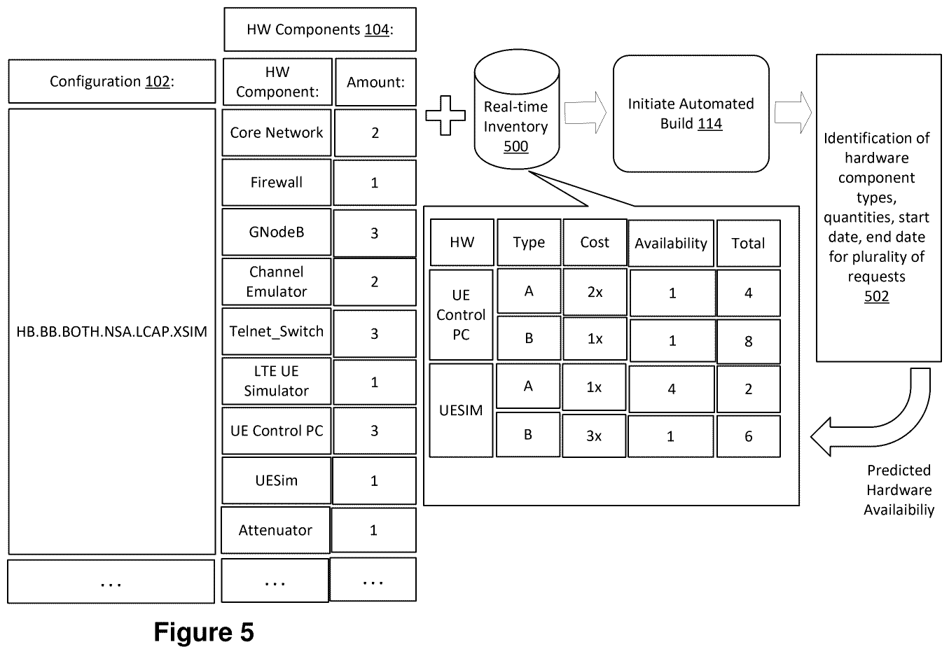

FIG. 5 is schematic diagram illustrating an example embodiment of generating (operation 104) the identification of a plurality of hardware components. The example embodiment further includes dynamically updating/notifying an inventory database. A Deep RL model can be used for building the requested cloud-native test bed. As shown in the example embodiment of FIG. 5, the identification of hardware components generated in operation 104 and data from a real-time, dynamic inventory are inputs for initiating the automated build of the requested test bed.

An identifier for the configuration 102 in FIG. 5 is provided: HB.BB.BOTH.NSA.LCAP.XSIM. The computing device generates 104, from a ML model based on the configuration, an identification of a plurality of hardware components that satisfy the configuration. As illustrated in the example of FIG. 5, the identification includes hardware components and their respective quantities:

| Hardware (HW) Component: | Amount: |
|---|---|
| Core Network | 2 |
| Firewall | 1 |
| GNodeB | 3 |
| Channel Emulator | 2 |
| Telnet_Switch | 3 |
| LTE Simulator | 1 |
| LTE UE Simulator | 1 |
| UE Control PC | 3 |
| UESim | 1 |
| Attenuator | 1 |
| . . . | . . . |

The identification of the hardware components that satisfy the configuration are notified to real-time inventory 500. An automated build of the requested test bed from the identification is initiated 114; and identification of the hardware types, quantities, and other data such as start date, end date for this request (as well as other requested) is used to predict availability of hardware components. The predicted hardware availability is used to update real-time inventory 500. As illustrated in the example embodiment of FIG. 5, the predicted hardware availability includes identification of hardware components, a hardware component type, a cost, availability, and a total quantity:

| HW | Type | Cost | Availability | Total |
|---|---|---|---|---|
| UE Control PC | A | 2x | 1 | 4 |
| | B | 1x | 1 | 8 |
| UESIM | A | 1x | 4 | 2 |
| | B | 3x | 1 | 6 |

The inclusion of the real-time, dynamic inventory may enable efficient use of the cloud-native hardware components. Table 2 below is an example of information that can be included in the dynamic inventory:

| | Hardware | | Capability | Predicted | Cost |
|---|---|---|---|---|---|
| | Component | Type | Type | Availability | Type |
| 1 | CHASSI | HW | Basic | Week 10 | Cost 1 |
| 2 | SPLITTER | HW | Basic | Week 8 | Cost 1 |
| 3 | ATTENUATOR | HW | Radio gateway | Week 12 | Cost 2 |
| | | | (Medium) | | |
| 4 | Radio base | HW | Radio gateway | Week 12 | Cost 2 |
| | station (RBS) | | (Medium) | | |
| 5 | MRUP | HW | UE (Advance) | Week 7 | Cost 3 |
| 6 | MODEM | HW | UE (Advance) | Week 8 | Cost 3 |

Hardware components can be assigned, assembled, and disassembled dynamically based on requests. Additionally, the hardware components also can be tagged and classified based on their complexity and applications. In some embodiments, the hardware components are classified into the following groups, where each class has a different cost:
Basic cloud RAN hardware components (Cost 1, Basic). This class can indicate the needed hardware components and cloud infrastructure for building a relatively simple test bed, e.g., a minimum basis of hardware components needed for building any type of the cloud-native test bed.
RGW cloud RAN hardware components (Cost 2, Medium). This class can represent the hardware components and cloud infrastructure for enabling the RGW functionality for a basic test bed. Thus, test beds that have a RGW have a higher capacity compared to a basic test bed.
UE test hardware components (Cost 3, Complex). This class can represent hardware components and cloud infrastructure for enabling UE capacities in a cloud-native test bed. A UE capacity can be the maximum capacity that a cloud-native test bed can have. Thus, this class of hardware components (e.g., in comparison to Cost 1, Basic and Cost 2, Medium) is the most complex and expensive types of hardware components.

In some embodiments, the initiating (operation 114 of FIG. 1) the automated build further includes notifying an inventory of a time of future availability of the plurality of hardware components.

The inventory may include, for a respective hardware component in the inventory, one of more of (i) an identifier for the hardware component, (ii) a type of the hardware component, (iii) a capability type for the hardware component, (iv) a time for availability of the hardware component, and (v) a cost information for the hardware component.

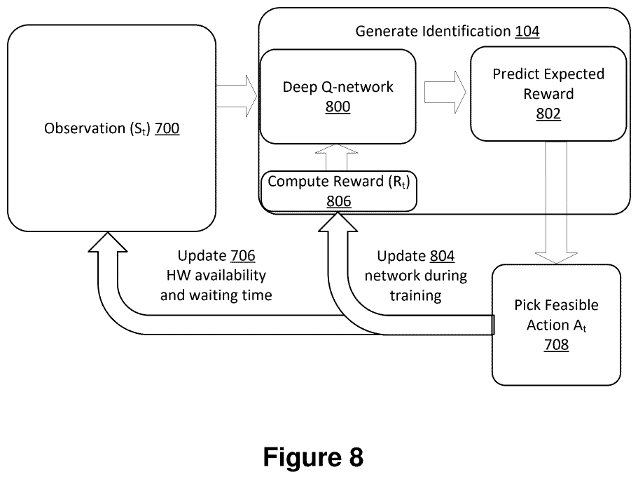

An example embodiment of a method in accordance with the present disclosure was implemented in Python. It is noted that while the implementation was done in Python, the method of the present disclosure is not so limited and can be implemented in the cloud. FIG. 8 discussed further herein provides a schematic overview for a cloud implementation.

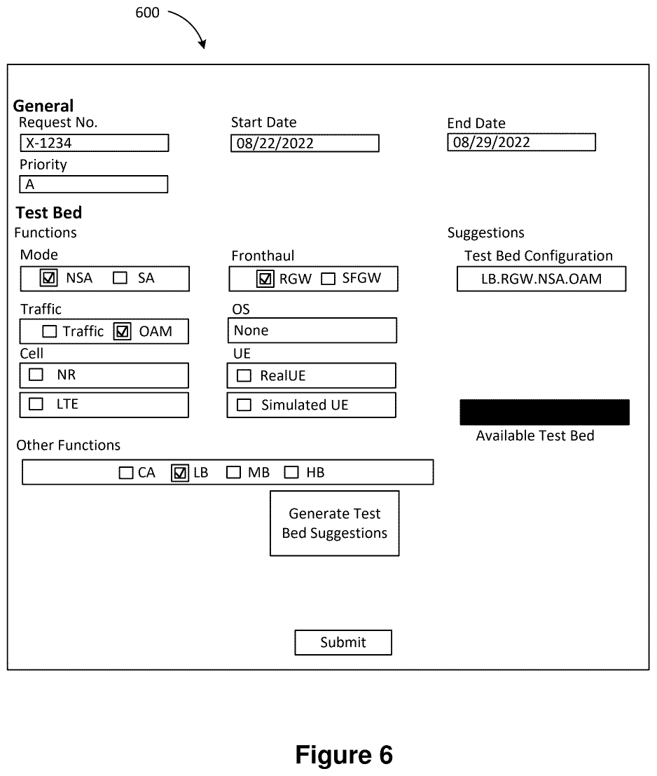

The example embodiment implemented in Python included a graphical user interface (GUI). FIG. 6 is schematic diagram illustrating the GUI 600 for the example embodiment that can be used by end-users (e.g., testers, integrators, etc.) for building a requested cloud-native test bed. The GUI 600 was used to capture attributes and data that can be received by a computing device. The data (which also can be referred to as metadata) in the example in FIG. 6 includes a Request Number, a Start Date, and End Date and a Priority level of the request for the test bed. The attributes of the cloud-native RAN for the request test bed in FIG. 6 includes a mode (checked as NSA), a Fronthaul (checked as RGW), Traffic (checked as OAM), no operating system (OS), no cell is checked, no UE is checked, and another function, LB is checked. The GUI 600 also includes a “Generate Test Bed Suggestions” button and a “Submit” button. As illustrated in the example of FIG. 6, a suggested Test Bed Configuration is displayed (LB.RGW.NSA.OAM) that matches the inputted attributes; and the display further indicates that there is an available test bed for this test bed configuration.

The data/metadata entered on GUI 600 can be used to help estimate the life span of each test bed. As previously discussed, maintaining a test bed for a long time may not be an optimal decision due to dynamic changes in a cloud application. Capturing the data/metadata via using an end-user's input as illustrated in FIG. 6 can help the computing device to do the following, for example:
1. Estimate the start time of building a new cloud-native test bed.
2. Estimate the life span of the test bed, which can be used for maintenance planning and a footprint cost for the test bed.
3. The end date can help, e.g., a lab team in planning the disassembling of a test bed if the computing device does not receive a similar request for building a new test bed with the same configuration.
4. Prioritize upcoming requests based on the request's priority. In a dynamic testing process for testing a cloud application, the computing device may receive several requests for building different cloud-native test beds at or about the same time. In this situation, several factors (e.g., hardware component(s) availability, cost, manpower, etc.) can be considered, where the priority of each request can be the most important factor.

The attributes selected on GUI 600 also can be received by the computing device. As previously discussed, a cloud-native test bed can have several capabilities/features. Understanding the configuration of the cloud-native test bed can require deep knowledge of the cloud RAN domain. As illustrated in FIG. 6, important attributes (e.g., high-level cloud RAN attributes) are identified and provided on GUI 600 for an end users to select. Moreover, there can be a binary relation between some of the attributes available for selection on the GUI 600. For example, in FIG. 6, a cloud-native test bed can be either OAM or traffic. While certain embodiments herein are discussed with regard to example dependencies and binary relations, the present disclosure is not limited to the examples and other dependencies and binary relations between attributes of a cloud-native cloud RAN test bed are included.

In an example embodiment, the receiving (operation 100 of FIG. 1) further includes receiving data including one of more of a time period for the requested test bed, an identifier of a request for the requested test bed, and a priority level of the requested test bed, and the generating (operation 102 of FIG. 1) uses the plurality of attributes to identify the configuration and the received data to identify at least one of a duration and a priority level for the requested test bed.

In some embodiments, as illustrated in FIG. 6, the cloud-native test bed's capacities are classified into four main groups: (1) Fronthaul Capability, (2) Traffic Capability, (3) Traffic Special Capability, and (4) Platform Capability. However, in other embodiments, some of these features/capabilities can be eliminated and merged, or a new feature(s) can be added to a cloud-native test bed attributes. As a consequence, methods of the present disclosure include an ability to adapt to future changes.

As previously discussed, some approaches do not pay attention to the test bed's configuration which may lead to overestimating or underestimating the capacity of a test bed; which also may directly impact the total cost of utilizing the resources. In contrast, operations of the present disclosure include a set of rules that identifies dependencies, e.g., as illustrated in the example in Table 1 herein.

The Test Bed Configuration illustrated on GUI 600 of FIG. 6 is a configuration generated in accordance with some embodiments. After an end-user selects attributes on GUI 600 for building a requested test bed, clicks on Generate a Test Bed Suggestion, and clicks on submit, the computing device can provide the corresponding, generated Test Bed Configuration. As illustrated in FIG. 6, the generated configuration includes an identifier (LB.RGW.NSA.OAM in FIG. 6) that identifies at least one or more of the plurality of attributes of the cloud-native RAN and at least one or more hardware components for the requested test bed. The generated configuration is used as an input for generating (operation 104 discussed herein from a ML model based an identification of a plurality of hardware components that satisfy the configuration.

In order to try to utilize the cloud RAN hardware components in an efficient manner, in the example implementation, the following criteria and the data/metadata entered on GUI 600 was considered for building the requested cloud-native test bed:
a. The cost of each hardware component: As illustrated in Table 2, for each hardware component, there may be several types or brands with different costs (e.g., a server can be ordered from Dell or HP company). The hardware cost may be a direct cost; however, the total cost of a cloud-native test bed can also include the following examples of indirect and direct costs:
   1. Software Cost+License (direct cost), platform cost (e.g., for a particular platform vendor).
   2. Operation Cost=Test bed configuration, complexity, and manpower cost (indirect cost).
   3. Footprint and Size (indirect cost).
   4. Power and connection cost (indirect cost).
b. The availability of each hardware component predicted by the ML model. In addition to the total cost for utilizing a cloud-native test bed, the availability of each hardware component can be monitored as well. In some embodiments, the task of building a cloud-native test bed is dynamic task. For example, several requests may be submitted per day, and each request may require a different infrastructure. For each decision (that is, building a requested cloud-native test bed), the availability of the hardware components can be checked in advance.
c. The priority of each request from the data/metadata. Each request for building a new cloud-native test bed can have a different priority due to, e.g., the delivery plan. The priority can be indicated as A, B, and C, or as numbers 1.2, and 2.2, for example. The priority information can be included as part of metadata extraction. Knowing the priority of each request in advance can help the computing device to change some of the decisions (e.g., preemption) and/or predict the next test bed.
d. The starting date and duration of each request from the data/metadata). Because different requests for building a new cloud-native test bed can have different priorities, the starting data and the life span of the newly built test bed can be specified in advance on UI G600. This information can help the computing device to predict when the cloud-native hardware components are available for the next test bed.

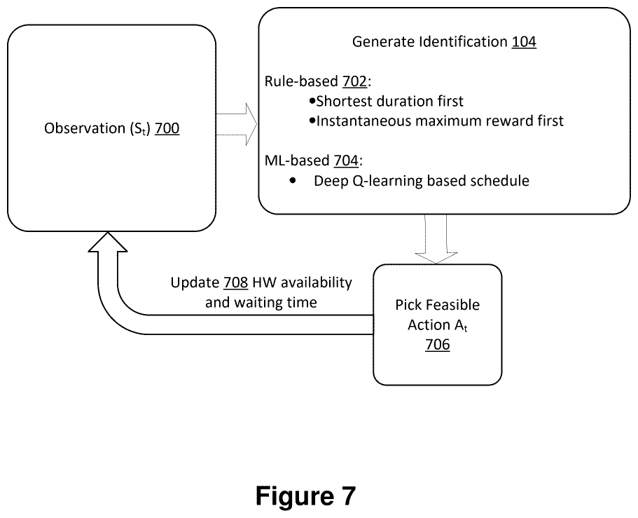

Using the inputs and criteria discussed herein, the computing device can dynamically create a hardware component level detailed plan for building test beds. FIG. 7 is a flowchart of operations of computing device in accordance with some embodiments. Two different strategies can be included to generate the identification (operation 104 discussed herein): rule based 702 and/or ML-based 704.

The rule-based strategy 702 can include (1) Shortest duration first, where a new request with the shortest duration is scheduled; or (2) Instantaneous maximum reward first, where a new request with a maximum reward computed at each time step is scheduled. The ML-based strategy 704 can include a Deep Q-learning based schedule.

The rule-based 702 or ML-based 704 strategy picks 706 a feasible action Aₜ, updates 708 hardware component availability and waiting time based on the action Aₜ, and observes a state Sₜ corresponding to the action Aₜ. The observation (Sₜ) can include the following, for example:

| | Request 1 | Request 2 | Request 3 | Request 4 | Request 5 |
|---|---|---|---|---|---|
| Waiting | 1 | 1 | 4 | 3 | 1 |
| times | | | | | |
| Usage | 4 | 1 | 2 | 4 | 1 |
| duration | | | | | |
| Priority | 1 | 1 | 3 | 2 | 2 |
| Required | 0 | 0 | 1 | 2 | 0 |
| hardware 1 | | | | | |
| Required | 1 | 2 | 0 | 1 | 3 |
| hardware 2 | | | | | |
| Required | 2 | 1 | 4 | 0 | 4 |
| hardware 3 | | | | | |

| | |
|---|---|
| Hardware | Time |

| Availability | t | t + 1 | t + 2 | t + 3 |
|---|---|---|---|---|
| Hardware 1 | 0 | 0 | 1 | 2 |
| Hardware 2 | 1 | 2 | 0 | 1 |
| Hardware 3 | 2 | 1 | 4 | 0 |

FIG. 8 is a flowchart of operations of a computing device in accordance with some embodiments that includes a Deep Q-learning based strategy. The example Deep Q-learning network 800 based strategy illustrated in FIG. 8 includes:
1. Observation (Sₜ) 700 is a concatenated vector of:
   i. Waiting time for each test bed build request
   ii. Predicted usage duration for each request
   iii. Priority for each request (from data/metadata)
   iv. Predicted quantity of each cloud-native hardware component needed for each request
   v. Predicted availability of each hardware component type for N future time steps
2. Action (Aₜ) is picked in operation 708 and is a scalar quantity that represents whether a request can be handled or that the agent should wait.
3. Episode: time duration from the start time to the end time of a schedule (from data/metadata)
4. Reward (Rₜ) is computed in operation 806. The reward (Rₜ) is a weighted sum of the following objectives:

$$i . {Obj}_{1} = 1 / {\sum }_{i} ( Waiting time of request i ) * ( Priority of request i ) )$$

$$ii . {Obj}_{2} = 1 / ( Hardware cost of the request assigned )$$

$$iii . {Obj}_{3} = ( Terminal cost of unassigned requests when episode ends )$$

5. Deep neural network 800 outputs a vector with predicted, expected rewards Q (Sₜ, Aₜ) 802, for each action given an observation. The deep network model 800 can be trained as follows
   i. Start with arbitrary initial weights θ for the deep neural network 800
   ii. Make observation (Sₜ) 700 and predict Q-values of all possible actions iii. Pick an action 708 using the epsilon-greedy policy. With epsilon probability, a random action with 1-epsilon probability can be chosen, an action can be picked with a maximum Q-value
   iv. Compute reward (Rₜ) 806 and update 706 a state of the environment (Sₜ+1)
   v. Using a gradient descent approach, update 804 network weights to θ′ that minimizes the mean-squared error (MSE):

$$MSE = {( {R}_{t} + γ * {max}_{a} Q ( {S}_{t + 1} , a ; {θ}^{′} ) - Q ( {S}_{t} , {A}_{t} ; θ ) )}^{2} ,$$

where y is a discount factor.

In an example embodiment, the reward value includes a weighted sum of (i) a waiting time of a request for the requested test bed and a priority level of the request, (ii) a cost of the plurality of hardware components that satisfy the configuration, and (iii) a cost of at least one unassigned request.

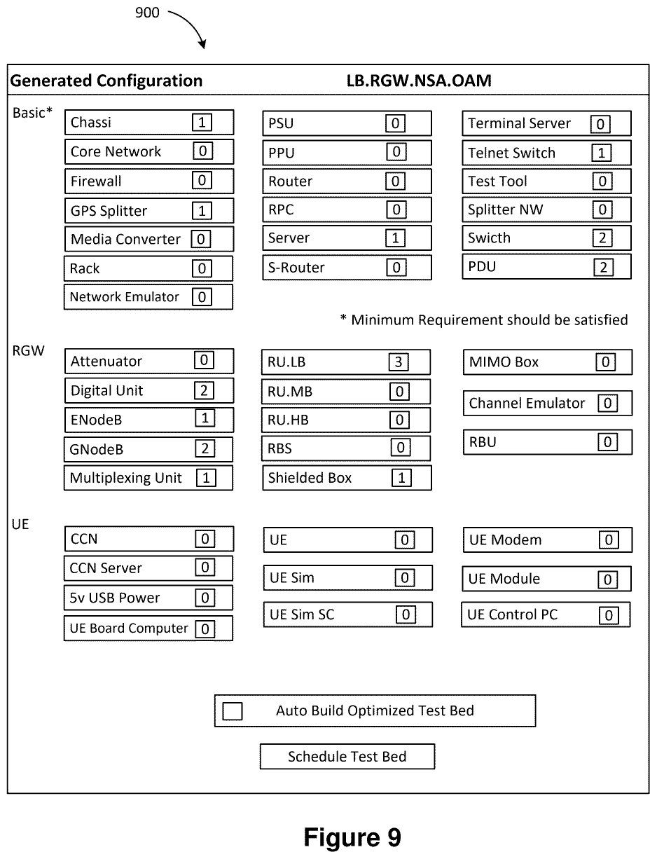

FIG. 9 is a schematic diagram of a GUI 900 from the example implementation that displays the identification of the plurality of hardware components that satisfy the configuration in the example implementation. As shown in the example of FIG. 9, the configuration is identified as LB.RGW.NSA.OAM; and the identification of hardware components that satisfy the configuration includes three classes of hardware components, Basic, RGW, and UE. As noted, the Basic class includes a minimum requirement of hardware components and quantities needed to satisfy a basic test bed. The illustrated Basic class includes one chassis, one global positioning system (GPS) splitter, one server, one Telnet switch, two switches, and two protocol data units (PDU); and no core network, firewall, media converter, rack, network emulator, power supply unit (PSU), packet processing unit (PPU), router, remote procedure call (RPC) S-router, terminal server, test tool, or network splitter.

The illustrated RGW class in FIG. 9 includes two digital units, one ENodeB, two GNodeB, one multiplexing unit, three RU.LB, one shielded box; and no attenuator, RU.MB, RU.HB, RBS, multiple input multiple output (MIMO) box, channel emulator, or radio baseband unit (RBU).

The illustrated UE class in FIG. 9 is inapplicable for the generated configuration and, there includes no content-centric networking (CCN), CCN server, Sv USB power, UE board computer, UE, UE Sim, UE Sim SC, UE modem, UE module, or UE control PC.

GUI 900 also includes an auto build optimized test bed that can be check by the end-user, and a schedule test bed button that can be clicked by the end-user. In some embodiments, the method further includes scheduling (operation 112 of FIG. 1) a build of the requested test bed. The scheduling includes reserving the plurality of hardware components that satisfy the configuration for a duration of the requested test bed and identifying a start time for the build based on an optimization objective and availability of the plurality of hardware components.

As discussed with reference to operation 114 of FIG. 1, an automated build of the requested test bed from the identification (e.g., from the information displayed in FIG. 9) is initiated. In an alternate embodiment, a build can be assembled (e.g., by people) from the identification (e.g., from the information displayed in FIG. 9).

Performance measurements were made for the hardware component prediction in the example implementation. The dataset utilized for the performance evaluation included 31 unique configurations; 190 unique hardware components; and 2471 total hardware components.

The following Table 3 includes a summary of performance evaluation of the example implementation using a rule-based approach:

| Hardware Component (2471 total) | Accuracy |
|---|---|
| CCN | 0.73 |
| Radio_Unit_LB | 0.53 |
| Radio_Unit_HB | 0.73 |
| TELNET_SWITCH | 0.53 |
| TERMINAL_SERVER | 0.92 |
| . . . | . . . |
| Average | 0.72 |

Table 4 below includes a summary of performance evaluation for dynamically building a cloud-native test bed of the example implementation using the rule-based strategies and a Deep-Q learning strategy discussed above regarding FIGS. 7 and 8, and 1000 total episodes (time duration from the start time to the end time of a schedule). Prior to the evaluation, the deep-Q learning neural network was trained with 15000 episodes:

| Test Bed Building | | Average Cumulative |
|---|---|---|
| Strategy | Approach | Reward |
| Rule-based strategy | Shortest duration first | 325.5 |
| Rule-based strategy | Instantaneous maximum | 325.9 |
| | reward first | |
| ML-based strategy | Deep-Q learning | 346.9 |

The inclusion of the different strategies may allow flexibility in choosing a strategy based on the size of the infrastructure and/or the number of upcoming requests. For example, a rules-based strategy may be selected for smaller datasets, and a ML-based strategy may be selected for larger datasets.

The method of various embodiments, therefore, can provide a platform to the end-users for automatically capturing attributes of a cloud RAN, and can be compatible with any automated control system that configures cloud-native infrastructures to build a test bed directly from end-user input, which may eliminate a need for lab technicians, for example. Based on inclusion, in some embodiments, of a set of rules that identifies dependencies for between (i) at least two attributes from the configuration, and/or between at least one hardware component and at least one attribute from the configuration, the dependencies may be automatically identified. Automatic generation of a configuration for respective requests can be automatically generated using ML-based and rule-based approaches. Further, some embodiments can generate the identification of hardware components that satisfy a generated configuration by considering: The delivery and end date of each testing request; the cost of each hardware component (e.g., by selecting the cheapest hardware of all available hardware components); the priority of each request; the duration of testing for each request; and/or the dependencies between the cloud infrastructures. Additionally, some embodiments provide a dynamic inventory that automatically and dynamically predicts the availability of the cloud-native hardware components. In an example embodiment, the generating (operation 104 of FIG. 1) the identification of the plurality of hardware components that satisfy the configuration is based on at least one of availability, a compatibility, and a cost of respective hardware components in the plurality of hardware components.

As a consequence, human effort may be reduced to forecast the capabilities of a cloud-native test bed; test bed building time and cost may be reduced; automatic decisions may be made without any human involvement for disassembling, modifying, or keeping a cloud-native test bed; and total cost may be minimized. Additionally, different test bed building strategies may be provided by considering the size of the cloud-native infrastructures, usage of the cloud-native infrastructures may be improved or optimized by considering the cost and automatically predicting the availability of the cloud-native infrastructures; and on-time delivery of cloud-based applications/products may be optimized or improved by prioritizing and planning the test bed build requests.

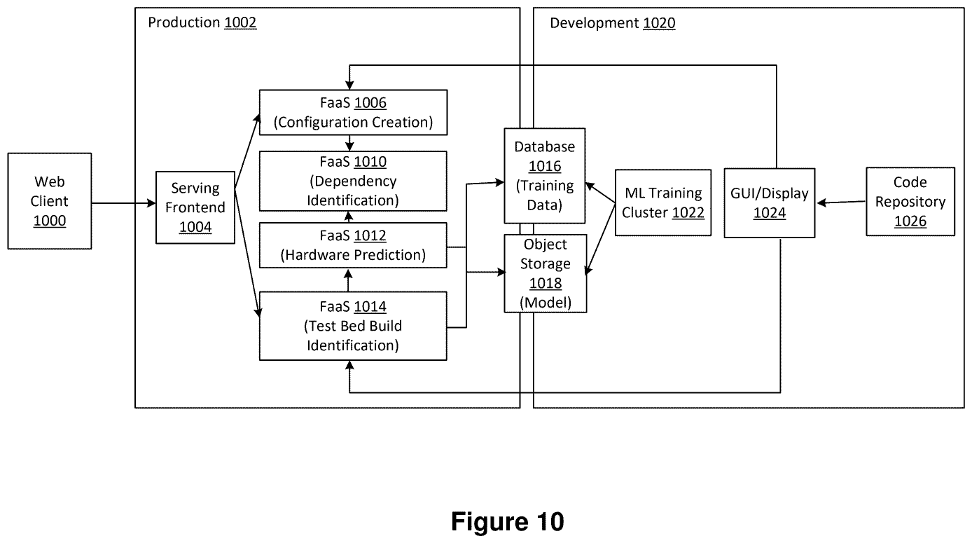

FIG. 10 is a block diagram of an overview of a distributed computing device illustrating a cloud implementation in accordance with some embodiments. A web client 1000 is communicatively coupled to distributed production 1002 logical devices/physical devices including: serving frontend 1004, function as a service (FaaS) 1006 that includes configuration creation (as discussed herein), FaaS 1010 that includes dependency identification (as discussed herein), FaaS 1012 that includes hardware component prediction (as discussed herein), and FaaS 1014 that includes test bed build identification (as discussed herein). FaaS 1012 and 1014, respectively, are communicatively coupled to database 1016 and object storage 1018. Database 1016 includes training data. Object storage 1018 includes a ML model. Database 1016 and object storage 1018 are communicatively coupled to a ML training cluster 1022 in distributed development 1020 logical devices/physical devices. Distributed development 1020 logical devices/physical devices further include: GUI/display 1024 (as discussed herein) and code repository 1026 communicatively coupled to GUI/display 1024. GUI/display 1024 is communicatively coupled to FaaS 1006, 1010, 1012, 1014 for performance of operations as discussed herein.

The computing device 1000 may also include multiple sets of components for different wireless technologies, for example Global System for Mobile Communications (GSM), Wideband Code Division Multiple Access (WCDMA), Long Term Evolution (LTE), New Radio (NR), wireless local area network (WLAN) standards, such as the Institute of Electrical and Electronics Engineers (IEEE) 802.11 standards (WiFi), Near Field Communication (NFC) Zigbee, Z-wave, long range wide area network (LoRaWAN), Radio Frequency Identification (RFID) or Bluetooth wireless technologies. These wireless technologies may be integrated into the same or different chip or set of chips and other components of computing device 1000.

Embodiments of the computing device 1000 may include additional components or functions beyond those shown in FIG. 10 for providing certain aspects of the computing device's functionality, including any of the functionality described herein and/or any functionality necessary to support the subject matter described herein. For example, the computing device 1000 may include user interface equipment to allow input of information into the computing device 1000 and to allow output of information from the computing device 1000. This may allow a user to perform diagnostic, maintenance, repair, and other administrative functions for the computing device 1000.

FIG. 11 illustrates two specific examples of how computing device 1000 (referred to as computing device 1100 in FIG. 11) may be implemented in certain embodiments of the present disclosure including: 1) a special-purpose computing device 1102 that uses custom processing circuits such as application-specific integrated-circuits (ASICs) and a proprietary operating system (OS); and 2) a general purpose computing device 1104 that uses COTS processors and a standard OS which has been configured to provide one or more of the features or functions disclosed herein.

Special-purpose computing device 1102 includes hardware 1110 comprising processor(s) 1112, and interface 1116, as well as memory 1118 having stored therein software 1120. In one embodiment, the software 1120 implements the modules described with regard to the previous figures. During operation, the software 1120 may be executed by the hardware 1110 to instantiate a set of one or more software instance(s) 1122. Each of the software instance(s) 1122, and that part of the hardware 1110 that executes that software instance (be it hardware dedicated to that software instance, hardware in which a portion of available physical resources (e.g., a processor core) is used, and/or time slices of hardware temporally shared by that software instance with others of the software instance(s) 1122), form a separate virtual network element 1130A-R. Thus, in the case where there are multiple virtual network elements 1130A-R, each operates as one of the network devices from the preceding figures.

Returning to FIG. 11, the example general purpose computing device 1104 includes hardware 1140 comprising a set of one or more processor(s) 1142 (which are often COTS processors) and interface 1146, as well as memory 1148 having stored therein software 1150. During operation, the processor(s) 1142 execute the software 1150 to instantiate one or more sets of one or more applications 1164A-R. While certain embodiments do not implement virtualization, alternative embodiments may use different forms of virtualization. For example, in certain alternative embodiments virtualization layer 1154 represents the kernel of an operating system (or a shim executing on a base operating system) that allows for the creation of multiple instances 1162A-R called software containers that may each be used to execute one (or more) of the sets of applications 1164A-R. In this embodiment, software containers 1162A-R (also called virtualization engines, virtual private servers, or jails) are user spaces (typically a virtual memory space) that may be separate from each other and separate from the kernel space in which the operating system is run. In certain embodiments, the set of applications running in a given user space, unless explicitly allowed, may be prevented from accessing the memory of the other processes. In other such alternative embodiments virtualization layer 1154 may represent a hypervisor (sometimes referred to as a virtual machine monitor (VMM)) or a hypervisor executing on top of a host operating system; and each of the sets of applications 1164A-R may run on top of a guest operating system within an instance 1162A-R called a virtual machine (which in some cases may be considered a tightly isolated form of software container that is run by the hypervisor). In certain embodiments, one, some or all of the applications are implemented as unikernel(s), which can be generated by compiling directly with an application only a limited set of libraries (e.g., from a library operating system (LibOS) including drivers/libraries of OS services) that provide the particular OS services needed by the application. As a unikernel can be implemented to run directly on hardware 1140, directly on a hypervisor (in which case the unikernel is sometimes described as running within a LibOS virtual machine), or in a software container, embodiments can be implemented fully with unikernels running directly on a hypervisor represented by virtualization layer 1154, unikernels running within software containers represented by instances 1162A-R, or as a combination of unikernels and the above-described techniques (e.g., unikernels and virtual machines both run directly on a hypervisor, unikernels and sets of applications that are run in different software containers).

The instantiation of the one or more sets of one or more applications 1164A-R, as well as virtualization if implemented are collectively referred to as software instance(s) 1152. Each set of applications 1164A-R, corresponding virtualization construct (e.g., instance 1162A-R) if implemented, and that part of the hardware 1140 that executes them (be it hardware dedicated to that execution and/or time slices of hardware temporally shared by software containers 1162A-R), forms a separate virtual network element(s) 1160A-R.

The virtual network element(s) 1160A-R perform similar functionality to the virtual network element(s) 1130A-R. This virtualization of the hardware 1140 is sometimes referred to as network function virtualization (NFV)). Thus, NFV may be used to consolidate many network equipment types onto industry standard high volume server hardware, physical switches, and physical storage, which could be located in for example data centers and customer premise equipment (CPE). However, different embodiments of the invention may implement one or more of the software container(s) 1162A-R differently. While embodiments of the invention are illustrated with each instance 1162A-R corresponding to one VNE 1160A-R, alternative embodiments may implement this correspondence at a finer level granularity; it should be understood that the techniques described herein with reference to a correspondence of instances 1162A-R to VNEs also apply to embodiments where such a finer level of granularity and/or unikernels are used.

The third example computing device implementation in FIG. 11 is a hybrid computing device 1106, which includes both custom ASICs/proprietary OS and COTS processors/standard OS in a single ND or a single card within an ND. In certain embodiments of such a hybrid computing device, a platform virtual machine (VM), such as a VM that that implements the functionality of the special-purpose computing device 1102, could provide for para-virtualization to the hardware present in the hybrid computing device 1106.

For reasons of simplicity and space many of the functions of the computing device previously described with reference to FIG. 11 have been left out from FIG. 12.

Although the devices described herein may include the illustrated combination of hardware components, other embodiments may comprise computing devices with different combinations of components. It is to be understood that these devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the device, and/or performing one or more operations based on the obtained information or converted information, and as a result of said processing making a determination. Moreover, while components are depicted as single boxes located within a larger box, or nested within multiple boxes, in practice, devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by a wireless network generally.

Further definitions and embodiments are discussed below.

In the above-description of various embodiments of present inventive concepts, it is to be understood that the terminology used herein is for the purpose of describing particular embodiments only and is not intended to be limiting of present inventive concepts. Unless otherwise defined, all terms (including technical and scientific terms) used herein have the same meaning as commonly understood by one of ordinary skill in the art to which present inventive concepts belong. It will be further understood that terms, such as those defined in commonly used dictionaries, should be interpreted as having a meaning that is consistent with their meaning in the context of this specification and the relevant art and will not be interpreted in an idealized or overly formal sense unless expressly so defined herein.

When an element is referred to as being “connected”, “coupled”, “responsive”, or variants thereof to another element, it can be directly connected, coupled, or responsive to the other element or intervening elements may be present. In contrast, when an element is referred to as being “directly connected”, “directly coupled”, “directly responsive”, or variants thereof to another element, there are no intervening elements present. Like numbers refer to like elements throughout. Furthermore, “coupled”, “connected”, “responsive”, or variants thereof as used herein may include wirelessly coupled, connected, or responsive. As used herein, the singular forms “a”, “an” and “the” are intended to include the plural forms as well, unless the context clearly indicates otherwise. Well-known functions or constructions may not be described in detail for brevity and/or clarity. The term “and/or” (abbreviated “/”) includes any and all combinations of one or more of the associated listed items.

It will be understood that although the terms first, second, third, etc. may be used herein to describe various elements/operations, these elements/operations should not be limited by these terms. These terms are only used to distinguish one element/operation from another element/operation. Thus a first element/operation in some embodiments could be termed a second element/operation in other embodiments without departing from the teachings of present inventive concepts. The same reference numerals or the same reference designators denote the same or similar elements throughout the specification.

As used herein, the terms “comprise”, “comprising”, “comprises”, “include”, “including”, “includes”, “have”, “has”, “having”, or variants thereof are open-ended, and include one or more stated features, integers, elements, steps, components or functions but does not preclude the presence or addition of one or more other features, integers, elements, steps, components, functions or groups thereof. Furthermore, as used herein, the common abbreviation “e.g.”, which derives from the Latin phrase “exempli gratia,” may be used to introduce or specify a general example or examples of a previously mentioned item, and is not intended to be limiting of such item. The common abbreviation “i.e.”, which derives from the Latin phrase “id est,” may be used to specify a particular item from a more general recitation.

Example embodiments are described herein with reference to block diagrams and/or flowchart illustrations of computer-implemented methods, apparatus (systems and/or devices) and/or computer program products. It is understood that a block of the block diagrams and/or flowchart illustrations, and combinations of blocks in the block diagrams and/or flowchart illustrations, can be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that can direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the examples of embodiments are intended to cover all such modifications, enhancements, and other embodiments, which fall within the spirit and scope of present inventive concepts. Thus, to the maximum extent allowed by law, the scope of present inventive concepts are to be determined by the broadest permissible interpretation of the present disclosure including the examples of embodiments and their equivalents, and shall not be restricted or limited by the foregoing detailed description.

1. A computer implemented method performed by a computing device for initiation of a build of a cloud-native radio access network, RAN, test bed, the method comprising:
receiving a plurality of attributes of the cloud-native RAN for requested test bed;
generating, based on the plurality of attributes, a configuration for the requested test bed, the configuration comprising an identifier that identifies at least one or more of the plurality of attributes of the cloud-native RAN and at least one or more hardware components for the requested test bed;
generating, from a machine learning, ML, model based on the configuration, an identification of a plurality of hardware components that satisfy the configuration; and
initiating an automated build of the requested test bed from the identification.

2. The method of claim 1, further comprising:
scheduling a build of the requested test bed, the scheduling comprising reserving the plurality of hardware components that satisfy the configuration for a duration of the requested test bed and identifying a start time for the build based on an optimization objective and availability of the plurality of hardware components.

3. The method of claim 1, wherein the generating the identification of the plurality of hardware components that satisfy the configuration is based on at least one of availability, a compatibility, and a cost of respective hardware components in the plurality of hardware components.

4. The method of claim 1, wherein the plurality of attributes comprise one or more of a radio spectrum, a model, brand, or name of a simulator, a type of user equipment (UE), a cell type, a quantity of cells, a type of RAN support, a standalone or a non-standalone mode, a type of traffic, and a radio gateway.

5. The method of claim 1, wherein the receiving further comprises receiving data comprising one of more of a time period for the requested test bed, an identifier of a request for the requested test bed, and a priority level of the requested test bed, and the generating uses the plurality of attributes to identify the configuration and the received data to identify at least one of a duration and a priority level for the requested test bed.

6. The method of claim 1, wherein the generating the configuration comprises analyzing the at least one or more of the plurality of attributes of the cloud-native RAN and the at least one or more hardware components for the requested test bed from the configuration based on use of a set of rules that identifies dependencies between at least two attributes from the configuration, and/or between at least one hardware component and at least one attribute from the configuration.

7. The method of claim 1, wherein the ML model comprises one of a rule-based model and a ML regression model, and wherein the generating the identification of the plurality of hardware components that satisfy the configuration comprises: providing the configuration to the ML model, and selecting the plurality of hardware components that satisfy the configuration based on calculation of a reward value.

8. The method of claim 7, wherein the reward value comprises a weighted sum of a waiting time of a request for the requested test bed and a priority level of the request, a cost of the plurality of hardware components that satisfy the configuration, and a cost of at least one unassigned request.

9. The method of claim 1, wherein the identification of a plurality of hardware components that satisfy the configuration comprises an identification of a quantity of each hardware component from the plurality of hardware components.

10. The method of claim 1, further comprising:
disassembling an existing test bed comprising a plurality of hardware components when the requested test bed is not satisfied by the existing test bed and a time period for use of the existing test bed has expired; and
allocating to a real-time inventory the plurality of hardware components for the disassembled test bed.

11. The method of claim 1, wherein the initiating the automated build further comprises notifying an inventory of a time of future availability of the plurality of hardware components.

12. The method of claim 10, wherein the inventory comprises, for a respective hardware component in the inventory, one of more of an identifier for the hardware component, a type of the hardware component, a capability type for the hardware component, a time for availability of the hardware component, and a cost information for the hardware component.

13. The method of claim 12, further comprising:
displaying on one of a graphical user interface or a display the configuration, and an indicator for a user of the display to provide an instruction to initiate the build.

14. A computing device configured for initiation of a build of a cloud-native radio access network, RAN, test bed, the computing device comprising:
processing circuitry;
memory coupled with the processing circuitry, wherein the memory includes instructions that when executed by the processing circuitry causes the computing device to perform operations comprising:
receive a plurality of attributes of the cloud-native RAN for requested test bed;
generate, based on the plurality of attributes, a configuration for the requested test bed, the configuration comprising an identifier that identifies at least one or more of the plurality of attributes of the cloud-native RAN and at least one or more hardware components for the requested test bed;
generate, from a machine learning, ML, model based on the configuration, an identification of a plurality of hardware components that satisfy the configuration; and
initiate an automated build of the requested test bed from the identification.

15-19. (canceled)

20. A computer program product comprising a non-transitory storage medium including program code to be executed by processing circuitry of a computing device configured for initiation of a build of a cloud-native radio access network, RAN, test bed, whereby execution of the program code causes the computing device to perform operations comprising:
receive a plurality of attributes of the cloud-native RAN for requested test bed;
generate, based on the plurality of attributes, a configuration for the requested test bed, the configuration comprising an identifier that identifies at least one or more of the plurality of attributes of the cloud-native RAN and at least one or more hardware components for the requested test bed;
generate, from a machine learning, ML, model based on the configuration, an identification of a plurality of hardware components that satisfy the configuration; and
initiate an automated build of the requested test bed from the identification.

21. (canceled)
